(19) United States
(12) Patent Application Publication
(10) Pub. No.: US 2011/0149022 A1
(43) Pub. Date: Jun. 23, 2011

(54) METHOD AND SYSTEM FOR GENERATING 3D OUTPUT VIDEO WITH 3D LOCAL GRAPHICS FROM 3D INPUT VIDEO

(76) Inventors: Ilya Klebanov, Thornhill (CA); Xuemin Chen, Rancho Santa Fe, CA (US); Samir Hulyalkar, Newtown, PA (US); Marcus Kellerman, San Diego, CA (US)

(21) Appl. No.: 12/698,690

(22) Filed: Feb. 2, 2010

Related U.S. Application Data
(60) Provisional application No. 61/287,653, filed on Dec. 17, 2009.
(60) Provisional application No. 61/287,624, filed on Dec. 17, 2009.
(60) Provisional application No. 61/287,634, filed on Dec. 17, 2009.
(60) Provisional application No. 61/287,668, filed on Dec. 17, 2009.
(60) Provisional application No. 61/287,673, filed on Dec. 17, 2009.
(60) Provisional application No. 61/287,682, filed on Dec. 17, 2009.
(60) Provisional application No. 61/287,689, filed on Dec. 17, 2009.
(60) Provisional application No. 61/287,692, filed on Dec. 17, 2009.

(51) Int. Cl. H04N 13/00

(52) U.S. Cl. 348/42; 348/E13.001; 348/569

(57) ABSTRACT

A video processing device may extract a plurality of view sequences from a three-dimensional (3D) input video stream and generate a plurality of graphics sequences that correspond to local graphics content. Each of the plurality of graphics sequences may be blended with a corresponding view sequence from the extracted plurality of view sequences to generate a plurality of combined sequences The local graphics content may comprise on-screen display (OSD) graphics, and may initially be generated as two-dimensional (2D) graphics. The plurality of graphics sequences may be generated from the local graphics content, based on, for example, video information for the input 3D video stream, user input, and/or preconfigured conversion data. After blending the view sequences with the graphics sequences, the video processing device may generate a 3D output video stream. The generated 3D output video stream may then be transformed to 2D video stream if 3D playback is not available.

### CROSS-REFERENCE TO RELATED APPLICATIONS/INCORPORATION BY REFERENCE

This patent application makes reference to, claims priority to and claims benefit from U.S. Provisional Application Ser. No. 61/287,653 (Attorney Docket Number 20683US01) which was filed on Dec. 17, 2009.

This application also makes reference to:
U.S. Provisional Application Ser. No. 61/287,624 (Attorney Docket Number 20677US01) which was filed on Dec. 17, 2009;
U.S. Provisional Application Ser. No. 61/287,634 (Attorney Docket Number 20678US01) which was filed on Dec. 17, 2009;
U.S. application Ser. No. 12/554,416 (Attorney Docket Number 20679US01) which was filed on Sep. 4, 2009;
U.S. application Ser. No. 12/546,644 (Attorney Docket Number 20680US01) which was filed on Aug. 24, 2009;
U.S. application Ser. No. 12/619,461 (Attorney Docket Number 20681US01) which was filed on Nov. 6, 2009;
U.S. application Ser. No. 12/578,048 (Attorney Docket Number 20682US01) which was filed on Oct. 13, 2009;
U.S. application Ser. No. 12/604,980 (Attorney Docket Number 20684US02) which was filed on Oct. 23, 2009;
U.S. application Ser. No. 12/545,679 (Attorney Docket Number 20686US01) which was filed on Aug. 21, 2009;
U.S. application Ser. No. 12/560,554 (Attorney Docket Number 20687US01) which was filed on Sep. 16, 2009;
U.S. application Ser. No. 12/560,578 (Attorney Docket Number 20688US01) which was filed on Sep. 16, 2009;
U.S. application Ser. No. 12/560,592 (Attorney Docket Number 20689US01) which was filed on Sep. 16, 2009;
U.S. application Ser. No. 12/604,936 (Attorney Docket Number 20690US01) which was filed on Oct. 23, 2009;
U.S. Provisional Application Ser. No. 61/287,668 (Attorney Docket Number 20691US01) which was filed on Dec. 17, 2009;
U.S. application Ser. No. 12/573,746 (Attorney Docket Number 20692US01) which was filed on Oct. 5, 2009;
U.S. application Ser. No. 12/573,771 (Attorney Docket Number 20693US01) which was filed on Oct. 5, 2009;
U.S. Provisional Application Ser. No. 61/287,673 (Attorney Docket Number 20694US01) which was filed on Dec. 17, 2009;
U.S. Provisional Application Ser. No. 61/287,682 (Attorney Docket Number 20695US01) which was filed on Dec. 17, 2009;
U.S. application Ser. No. 12/605,039 (Attorney Docket Number 20696US01) which was filed on Oct. 23, 2009;
U.S. Provisional Application Ser. No. 61/287,689 (Attorney Docket Number 20697US01) which was filed on Dec. 17, 2009; and
U.S. Provisional Application Ser. No. 61/287,692 (Attorney Docket Number 20698US01) which was filed on Dec. 17, 2009.

Each of the above stated applications is hereby incorporated herein by reference in its entirety

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to video processing. More specifically, certain embodiments of the invention relate to a method and system for generating 3D output video with 3D local graphics from 3D input video.

### BACKGROUND OF THE INVENTION

Display devices, such as television sets (TVs), may be utilized to output or playback audiovisual or multimedia streams, which may comprise TV broadcasts, telecasts and/or localized Audio/Video (A/V) feeds from one or more available consumer devices, such as videocassette recorders (VCRs) and/or Digital Video Disc (DVD) players. TV broadcasts and/or audiovisual or multimedia feeds may be inputted directly into the TVs, or it may be passed intermediately via one or more specialized set-top boxes that may enable providing any necessary processing operations. Exemplary types of connectors that may be used to input data into TVs include, but not limited to, F-connectors, S-video, composite and/or video component connectors, and/or, more recently, High-Definition Multimedia Interface (HDMI) connectors.

Television broadcasts are generally transmitted by television head-ends over broadcast channels, via RF carriers or wired connections. TV head-ends may comprise terrestrial TV head-ends, Cable-Television (CATV), satellite TV head-ends and/or broadband television head-ends. Terrestrial TV head-ends may utilize, for example, a set of terrestrial broadcast channels, which in the U.S. may comprise, for example, channels 2 through 69. Cable-Television (CATV) broadcasts may utilize even greater number of broadcast channels. TV broadcasts comprise transmission of video and/or audio information, wherein the video and/or audio information may be encoded into the broadcast channels via one of plurality of available modulation schemes. TV Broadcasts may utilize analog and/or digital modulation format. In analog television systems, picture and sound information are encoded into, and transmitted via analog signals, wherein the video/audio information may be conveyed via broadcast signals, via amplitude and/or frequency modulation on the television signal, based on analog television encoding standard. Analog television broadcasters may, for example, encode their signals using NTSC, PAL and/or SECAM analog encoding and then modulate these signals onto a VHF or UHF RF carriers, for example.

In digital television (DTV) systems, television broadcasts may be communicated by terrestrial, cable and/or satellite head-ends via discrete (digital) signals, utilizing one of available digital modulation schemes, which may comprise, for example, QAM, VSB, QPSK and/or OFDM. Because the use of digital signals generally requires less bandwidth than analog signals to convey the same information, DTV systems may enable broadcasters to provide more digital channels within the same space otherwise available to analog television systems. In addition, use of digital television signals may enable broadcasters to provide high-definition television (HDTV) broadcasting and/or to provide other non-television related service via the digital system. Available digital television systems comprise, for example, ATSC, DVB, DMB-T/H and/or ISDN based systems. Video and/or audio information may be encoded into digital television signals utilizing various video and/or audio encoding and/or compression algorithms, which may comprise, for example, MPEG-1/2, MPEG-4 AVC, MP3, AC-3, AAC and/or HE-AAC.

Nowadays most TV broadcasts (and similar multimedia feeds), utilize video formatting standard that enable communication of video images in the form of bit streams. These video standards may utilize various interpolation and/or rate conversion functions to present content comprising still and/or moving images on display devices. For example, de-interlacing functions may be utilized to convert moving and/or still images to a format that is suitable for certain types of display devices that are unable to handle interlaced content. TV broadcasts, and similar video feeds, may be interlaced or progressive. Interlaced video comprises fields, each of which may be captured at a distinct time interval. A frame may comprise a pair of fields, for example, a top field and a bottom field. The pictures forming the video may comprise a plurality of ordered lines. During one of the time intervals, video content for the even-numbered lines may be captured. During a subsequent time interval, video content for the odd-numbered lines may be captured. The even-numbered lines may be collectively referred to as the top field, while the odd-numbered lines may be collectively referred to as the bottom field. Alternatively, the odd-numbered lines may be collectively referred to as the top field, while the even-numbered lines may be collectively referred to as the bottom field. In the case of progressive video frames, all the lines of the frame may be captured or played in sequence during one time interval. Interlaced video may comprise fields that were converted from progressive frames. For example, a progressive frame may be converted into two interlaced fields by organizing the even numbered lines into one field and the odd numbered lines into another field.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for generating 3D output video with 3D local graphics from 3D input video, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary video system that supports TV broadcasts and/or local multimedia feeds, in accordance with an embodiment of the invention.

FIG. 2A is a block diagram illustrating an exemplary video system that may be operable to provide communication of 3D video, in accordance with an embodiment of the invention.

FIG. 2B is a block diagram illustrating an exemplary video processing system that may be operable to generate video streams comprising 3D video, in accordance with an embodiment of the invention.

FIG. 2C is a block diagram illustrating an exemplary video processing system that may be operable to process and display video input comprising 3D video, in accordance with an embodiment of the invention.

FIG. 3 is a flow chart that illustrates exemplary steps for generating 3D output video with 3D local graphics from 3D input video, in accordance with an embodiment of the invention.

### DETAILED DESCRIPTION OF THE INVENTION

Certain embodiments of the invention may be found in a method and system for generating three-dimensional (3D) output video with 3D local graphics from 3D input video. In various embodiments of the invention, a video processing device may extract a plurality of view sequences from three-dimension (3D) input video streams and generate a plurality of graphics sequences that correspond to local graphics content. Each of the plurality of graphics sequences may be blended with a corresponding view sequence from the extracted plurality of view sequences to generate a plurality of combined sequences. The local graphics content may comprise on-screen display (OSD) graphics. The local graphics content may initially be generated as two-dimensional (2D) graphics. The extracted plurality of view sequences may comprise stereoscopic left and right view sequences of frames or fields. Accordingly, when the plurality of graphics sequences are generated, left and right graphics sequences that correspond to the stereoscopic left and right view sequences may be generated. The right graphics sequence may then be blended with the stereoscopic right view sequence and/or the left graphics sequence may be blended with the stereoscopic left view sequence. The plurality of graphics sequences may be generated from the local graphics content, based on, for example, the input 3D video stream, user input, and/or preconfigured conversion parameters. After blending the plurality of graphics sequences with the plurality of the view sequences, the video processing device may generate a 3D output video stream based on the plurality of combined sequences, for playback via a display device. The generated 3D output video stream may then be transformed to a 2D video stream if 3D playback is not available via the display device.

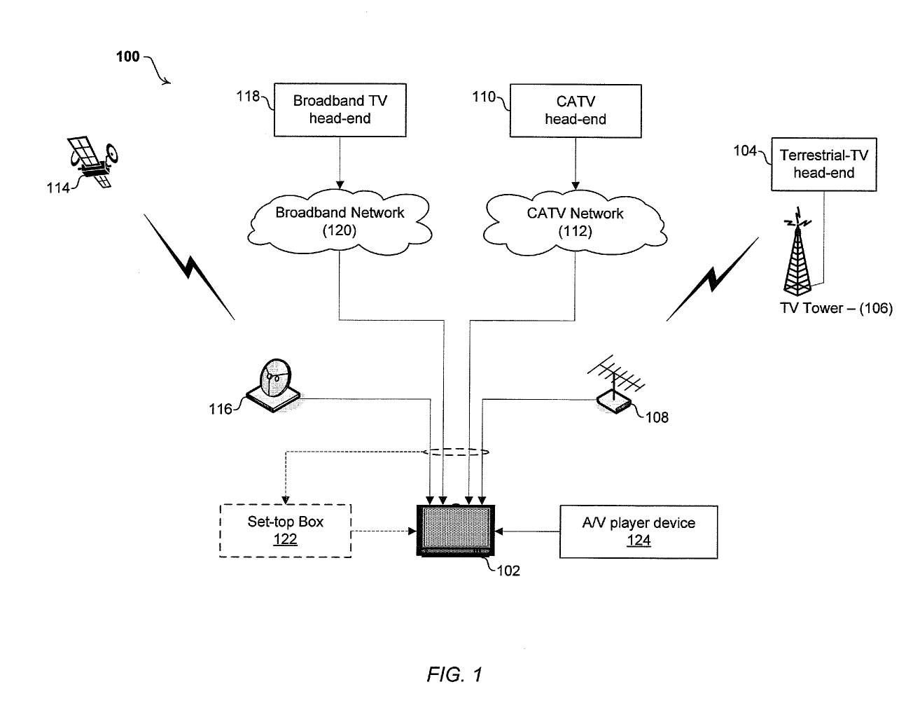

FIG. 1 is a block diagram illustrating an exemplary video system that supports TV broadcasts and/or local multimedia feeds, in accordance with an embodiment of the invention. Referring to FIG. 1, there is shown a media system 100, which may comprise a display device 102, a terrestrial-TV head-end 104, a TV tower 106, a TV antenna 108, a cable-TV (CATV) head-end 110, a cable-TV (CATV) distribution network 112, a satellite-TV head-end 114, a satellite-TV receiver 116, a broadband-TV head-end 118, a broadband network 120, a set-top box 122, and an audio-visual (AV) player device 124.

The display device 102 may comprise suitable logic, circuitry, interfaces and/or code that enable playing of multimedia streams, which may comprise audio-visual (AV) data. The display device 102 may comprise, for example, a television, a monitor, and/or other display and/or audio playback devices, and/or components that may be operable to playback video streams and/or corresponding audio data, which may be received, directly by the display device 102 and/or indirectly via intermediate devices, such as the set-top box 122, and/or from local media recording/playing devices and/or storage resources, such as the AV player device 124.

The terrestrial-TV head-end 104 may comprise suitable logic, circuitry, interfaces and/or code that may enable over-the-air broadcast of TV signals, via one or more of the TV tower 106. The terrestrial-TV head-end 104 may be enabled to broadcast analog and/or digital encoded terrestrial N signals. The N antenna 108 may comprise suitable logic, circuitry, interfaces and/or code that may enable reception of N signals transmitted by the terrestrial-TV head-end 104, via the N tower 106. The CAN head-end 110 may comprise suitable logic, circuitry, interfaces and/or code that may enable communication of cable-TV signals. The CAN head-end 110 may be enabled to broadcast analog and/or digital formatted cable-N signals. The CAN distribution network 112 may comprise suitable distribution systems that may enable forwarding of communication from the CAN head-end 110 to a plurality of cable-TV recipients, comprising, for example, the display device 102. For example, the CAN distribution network 112 may comprise a network of fiber optics and/or coaxial cables that enable connectivity between one or more instances of the CAN head-end 110 and the display device 102.

The satellite-TV head-end 114 may comprise suitable logic, circuitry, interfaces and/or code that may enable down link communication of satellite-TV signals to terrestrial recipients, such as the display device 102. The satellite-TV head-end 114 may comprise, for example, one of a plurality of orbiting satellite nodes in a satellite-TV system. The satellite-TV receiver 116 may comprise suitable logic, circuitry, interfaces and/or code that may enable reception of downlink satellite-TV signals transmitted by the satellite-TV head-end 114. For example, the satellite receiver 116 may comprise a dedicated parabolic antenna operable to receive satellite television signals communicated from satellite television head-ends, and to reflect and/or concentrate the received satellite signal into focal point wherein one or more low-noise-amplifiers (LNAs) may be utilized to down-convert the received signals to corresponding intermediate frequencies that may be further processed to enable extraction of audio/video data, via the set-top box 122 for example. Additionally, because most satellite-TV downlink feeds may be securely encoded and/or scrambled, the satellite-TV receiver 116 may also comprise suitable logic, circuitry, interfaces and/or code that may enable decoding, descrambling, and/or deciphering of received satellite-TV feeds.

The broadband-TV head-end 118 may comprise suitable logic, circuitry, interfaces and/or code that may enable multimedia/TV broadcasts via the broadband network 120. The broadband network 120 may comprise a system of interconnected networks, which enables exchange of information and/or data among a plurality of nodes, based on one or more networking standards, including, for example, TCP/IP. The broadband network 120 may comprise a plurality of broadband capable sub-networks, which may include, for example, satellite networks, cable networks, DVB networks, the Internet, and/or similar local or wide area networks, that collectively enable conveying data that may comprise multimedia content to plurality of end users. Connectivity may be provide via the broadband network 120 based on copper-based and/or fiber-optic wired connection, wireless interfaces, and/or other standards-based interfaces. The broadband-TV head-end 118 and the broadband network 120 may correspond to, for example, an Internet Protocol Television (IPTV) system.

The set-top box 122 may comprise suitable logic, circuitry, interfaces and/or code that may enable processing of TV and/or multimedia streams/signals transmitted by one or more TV head-ends external to the display device 102. The AV player device 124 may comprise suitable logic, circuitry, interfaces and/or code that enable providing video/audio feeds to the display device 102. For example, the AV player device 124 may comprise a digital video disc (DVD) player, a Blu-ray player, a digital video recorder (DVR), a video game console, a surveillance system, and/or a personal computer (PC) capture/playback card. While the set-top box 122 and the AV player device 124 are shown are separate entities, at least some of the functions performed via the top box 122 and/or the AV player device 124 may be integrated directly into the display device 102.

In operation, the display device 102 may be utilized to playback media streams received from one of available broadcast head-ends, and/or from one or more local sources. The display device 102 may receive, for example, via the TV antenna 108, over-the-air TV broadcasts from the terrestrial-TV head end 104 transmitted via the TV tower 106. The display device 102 may also receive cable-TV broadcasts, which may be communicated by the CATV head-end 110 via the CATV distribution network 112; satellite TV broadcasts, which may be communicated by the satellite head-end 114 and received via the satellite receiver 116; and/or Internet media broadcasts, which may be communicated by the broadband-TV head-end 118 via the broadband network 120.

TV head-ends may utilize various formatting schemes in TV broadcasts. Historically, TV broadcasts have utilized analog modulation format schemes, comprising, for example, NTSC, PAL, and/or SECAM. Audio encoding may comprise utilization of separate modulation scheme, comprising, for example, BTSC, NICAM, mono FM, and/or AM. More recently, however, there has been a steady move towards Digital TV (DTV) based broadcasting. For example, the terrestrial-TV head-end 104 may be enabled to utilize ATSC and/or DVB based standards to facilitate DTV terrestrial broadcasts. Similarly, the CAN head-end 110 and/or the satellite head-end 114 may also be enabled to utilize appropriate encoding standards to facilitate cable and/or satellite based broadcasts.

The display device 102 may be operable to directly process multimedia/TV broadcasts to enable playing of corresponding video and/or audio data. Alternatively, an external device, for example the set-top box 122, may be utilized to perform processing operations and/or functions, which may be operable to extract video and/or audio data from received media streams, and the extracted audio/video data may then be played back via the display device 102.

In exemplary aspect of the invention, the media system 100 may be operable to support three-dimensional (3D) video. Most video content is currently generated and played in two-dimensional (2D) format. There has been a recent push, however, towards the development and/or use of three-dimensional (3D) video. In various video related applications such as, for example, DVD/Blu-ray movies and/or digital TV, 3D video may be more desirable because it may be more realistic to humans to perceive 3D rather than 2D images. Various methodologies may be utilized to capture, generate (at capture or playtime), and/or render 3D video images. One of the more common methods for implementing 3D video is stereoscopic 3D video. In stereoscopic 3D video based application the 3D video impression is generated by rendering multiple views, most commonly two views: a left view and a right view, corresponding to the viewer's left eye and right eye to give depth to displayed images. In this regard, the left view and the right view sequences may be captured and/or processed to enable creating 3D images. The video data corresponding to the left view and right view sequences may then be communicated either as separate streams, or may be combined into a single transport stream and only separated into different view sequences by the end-user receiving/displaying device. The stereoscopic 3D video may communicated via TV broadcasts. In this regard, one or more of the TV head-ends may be operable to communicate 3D video content to the display device 102, directly and/or via the set-top box 122. The communication of stereoscopic 3D video may also be performed by use of multimedia storage devices, such as DVD or Blu-ray discs, which may be used to store 3D video data that subsequently may be played back via an appropriate player, such as the AV player device 124. Various compression/encoding standards may be utilized to enable compressing and/or encoding of the view sequences into transport streams during communication of stereoscopic 3D video. For example, the separate left and right view sequences may be compressed based on MPEG-2 MVP, H.264 and/or MPEG-4 advanced video coding (AVC) or MPEG-4 multi-view video coding (MVC).

In various embodiments of the invention, local graphics may be generated and/or incorporated into video received and/or displayed via the display device 102. In this regard, the local graphics may comprise on-screen display (OSD) graphics, which may comprise graphics that may be superimposed on screen to display, for example, certain information such as volume, channel, and time, and/or to enable user interactions for the purpose of, for example, adjusting and/or configuring the display device 102, and/or other devices that may be communicatively coupled to the display device 102 during video playback such as the set-top box 122 and/or the AV player device 124. For example, local graphics may comprise images depicting increase/decrease in the volume, and/or menu setting options that are displayed when the input and/or parameters of the display device 102 are adjusted.

In an exemplary aspect of the invention, where 3D video content is received via the display device 102, directly or via intermediary device such as the set-top box 122, the local graphics may be generated, or converted to 3D graphics content that may be blended with the input 3D video content. During blending, the input 3D video content which comprises stereoscopic view sequences, such as left and right view sequences of video frames or fields, the generated 3D graphics content may comprise a plurality of sequences each of which may be blended with a corresponding input video view sequence. In this regard, in instances where the input 3D video content comprises stereoscopic left and right view sequences, the 3D local graphics may also comprise left and right graphics sequences. The stereoscopic left view video sequence may then be blended with the left graphics sequence while the stereoscopic right view video sequence may be blended with the right graphics sequence. The combined view sequences may then be combined to generate an output 3D video stream for display via the display device 102. In instances where the display device 102 supports only 2D video, the output 3D video stream may be transformed to and/or reformatted as a 2D video steam compatible format.

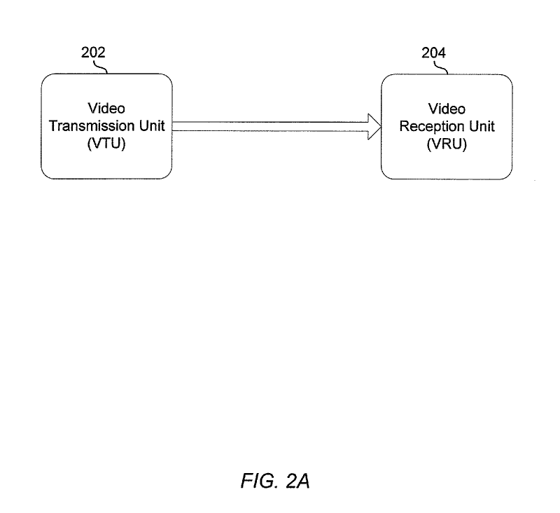

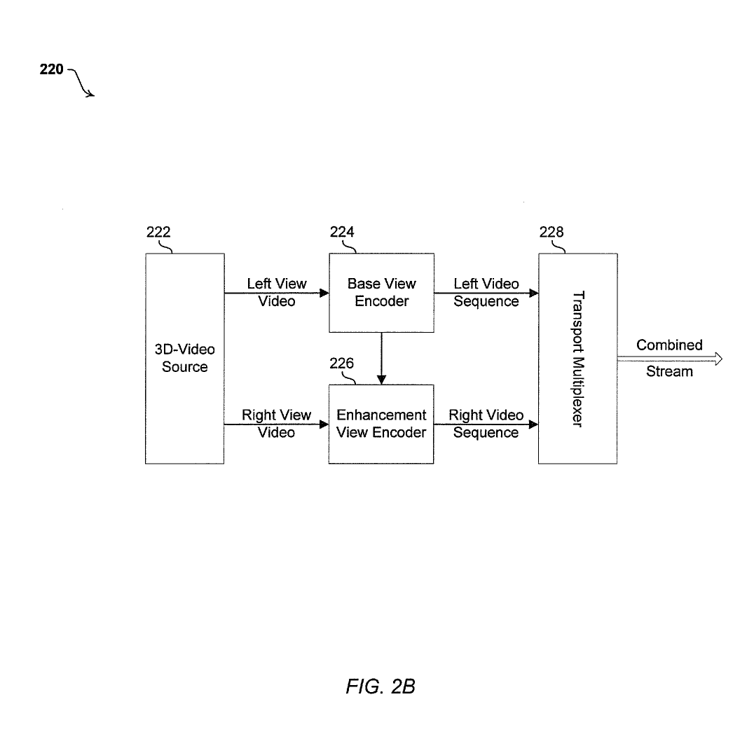

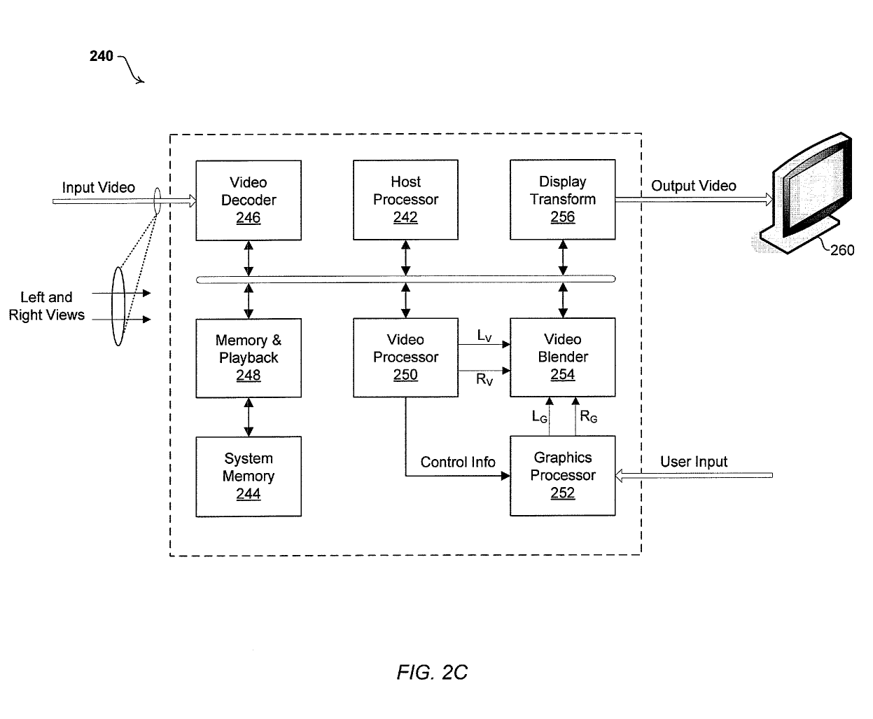

FIG. 2A is a block diagram illustrating an exemplary video system that may be operable to provide communication of 3D video, in accordance with an embodiment of the invention. Referring to FIG. 2A, there is shown a 3D video transmission unit (3D-VTU) 202 and a 3D video reception unit (3D-VRU) 204.

The 3D-VTU 202 may comprise suitable logic, circuitry, interfaces and/or code that may be operable to generate video streams that may comprise encoded/compressed 3D video data, which may be communicated, for example, to the 3D-VRU 204 for display and/or playback. The 3D video generated via the 3D-VTU 202 may be communicated via TV broadcasts, by one or more TV head-ends such as, for example, the terrestrial-TV head-end 104, the CAN head-end 110, the satellite head-end 114, and/or the broadband-TV head-end 118 of FIG. 1. The 3D video generated via the 3D-VTU 202 may be stored into multimedia storage devices, such as DVD or Blu-ray discs.

The 3D-VRU 204 may comprise suitable logic, circuitry, interfaces and/or code that may be operable to receive and process video streams comprising 3D video data for display and/or playback. The 3D-VRU 204 may be operable to, for example, receive and/or process transport streams comprising 3D video data, which may be communicated directly by, for example, the 3D-VTU 202 via TV broadcasts. The 3D-VRU 204 may also be operable receive video streams generated via the 3D-VTU 202, which are communicated indirectly via multimedia storage devices that may be played directly via the 3D-VRU 204 and/or via local suitable player devices. In this regard, the operations of the 3D-VRU 204 may be performed, for example, via the display device 102, the set-top box 122, and/or the AV player device 124 of FIG. 1. The received video streams may comprise encoded/compressed 3D video data. Accordingly, the 3D-VRU 204 may be operable to process the received video stream to separate and/or extract various video contents in the transport stream, and may be operable to decode and/or process the extracted video streams and/or contents to facilitate display operations.

In operation, the 3D-VTU 202 may be operable to generate video streams comprising 3D video data. The 3D-VTU 202 may encode, for example, the 3D video data as stereoscopic 3D video comprising left view and right view sequences. The 3D-VRU 204 may be operable to receive and process the video streams to facilitate playback of video content included in the video stream via appropriate display devices. In this regard, the 3D-VRU 204 may be operable to, for example, demultiplex received transport stream into encoded 3D video streams and/or additional video streams. The 3D-VRU 204 may be operable to decode the encoded 3D video data for display.

In various embodiments of the invention, the 3D-VRU 204 may be operable to generate and/or incorporate local graphics into video received, directly via broadcast and/or indirectly via multimedia storage devices, from the 3D-VTU 202. In this regard, the local graphics may comprise on-screen display (OSD) graphics, substantially as described with regard to, for example, FIG. 1. The local graphics may comprise, for example, images superimposed on a screen during playback of received video streams to show, for example, increase/decrease in the volume, time, and/or channel info. In an exemplary aspect of the invention, in instances where 3D video content is received via the 3D-VRU 204, the local graphics may be generated, or converted to 3D graphics content that may be blended with the input 3D video content. In instances when the received 3D video content comprises stereoscopic video based view sequences, such as left and right view sequences of video frames or fields, the generated 3D graphics content may comprise a plurality of sequences each of which may be blended with a corresponding input video view sequence.

FIG. 2B is a block diagram illustrating an exemplary video processing system that may be operable to generate video streams comprising 3D video, in accordance with an embodiment of the invention. Referring to FIG. 2B, there is shown a video processing system 220, a 3D-video source 222, a base view encoder 224, an enhancement view encoder 226, and a transport multiplexer 228.

The video processing system 220 may comprise suitable logic, circuitry, interfaces and/or code that may be operable to capture, generate, and/or process 3D video data, and to generate transport streams comprising the 3D video. The video processing system 220 may comprise, for example, the 3D-video source 222, the base view encoder 224, the enhancement view encoder 226, and/or the transport multiplexer 228. The video processing system 220 may be integrated into the 3D-VTU 202 to facilitate generation of video and/or transport streams comprising 3D video data.

The 3D-video source 222 may comprise suitable logic, circuitry, interfaces and/or code that may be operable to capture and/or generate source 3D video contents. The 3D-video source 222 may be operable to generate stereoscopic 3D video comprising video data for left view and right views from the captured source 3D video contents, to facilitate 3D video display/playback. The left view video and the right view video may be communicated to the base view encoder 224 and the enhancement view encoder 226, respectively, for video compressing.

The base view encoder 224 may comprise suitable logic, circuitry, interfaces and/or code that may be operable to encode the left view video from the 3D-video source 222, for example on frame by frame basis. The base view encoder 224 may be operable to utilize various video encoding and/or compression algorithms such as those specified in MPEG-2, MPEG-4, AVC, VC1, VP6, and/or other video formats to form compressed and/or encoded video contents for the left view video from the 3D-video source 222. In addition, the base view encoder 224 may be operable to communication information, such as the scene information from base view coding, to the enhancement view encoder 226 to be used for enhancement view coding.

The enhancement view encoder 226 may comprise suitable logic, circuitry, interfaces and/or code that may be operable to encode the right view video from the 3D-video source 222, for example on frame by frame basis. The enhancement view encoder 226 may be operable to utilize various video encoding and/or compression algorithms such as those specified in MPEG-2, MPEG-4, AVC, VC1, VP6, and/or other video formats to form compressed or encoded video content for the right view video from the 3D-video source 222. Although a single enhancement view encoder 226 is illustrated in FIG. 2B, the invention may not be so limited. Accordingly, any number of enhancement view video encoders may be used for processing the left view video and the right view video generated by the 3D-video source 222 without departing from the spirit and scope of various embodiments of the invention.

The transport multiplexer 228 may comprise suitable logic, circuitry, interfaces and/or code that may be operable to merge a plurality of video sequences into a single compound video stream. The combined video stream may comprise the left (base) view video sequence, the right (enhancement) view video sequence, and a plurality of addition video streams, which may comprise, for example, advertisement streams.

In operation, the 3D-video source 222 may be operable to capture and/or generate source 3D video contents to produce, for example, stereoscopic 3D video data that may comprise a left view video and a right view video for video compression. The left view video may be encoded via the base view encoder 224 producing the left (base) view video sequence. The right view video may be encoded via the enhancement view encoder 226 to produce the right (enhancement) view video sequence. The base view encoder 224 may be operable to provide information such as the scene information to the enhancement view encoder 226 for enhancement view coding, to enable generating depth data, for example. Transport multiplexer 228 may be operable to combine the left (base) view video sequence and the right (enhancement) view video sequence to generate a combined video stream. Additionally, one or more additional video streams may be multiplexed into the combined video stream via the transport multiplexer 228. The resulting video stream may then be communicated, for example, to the 3D-VRU 204, substantially as described with regard to FIG. 2A.

In an exemplary aspect of the invention, devices receiving video streams generated via the video processing system 220 may generate and/or incorporate local graphics, such as on-screen display (OSD) graphics, into the video streams during processing of these video streams.

FIG. 2C is a block diagram illustrating an exemplary video processing system that may be operable to process and display video input comprising 3D video, in accordance with an embodiment of the invention. Referring to FIG. 2C there is shown a video processing system 240, a host processor 242, a system memory 244, an video decoder 246, a memory and playback module 248, a video processor 250, a graphics processor 252, a video blender 254, a display transform module 256, and a display 260.

The video processing system 240 may comprise suitable logic, circuitry, interfaces and/or code that may be operable to receive and process 3D video data in a compression format and may render reconstructed output video for display. The video processing system 240 may comprise, for example, the host processor 242, the system memory 244, the video decoder 246, the memory and playback module 248, the video processor 250, the graphics processor 252, the video blender 254, and/or the display transform module 256. For example, the video processing system 240 may be integrated into the 3D-VRU 204 to facilitate reception and/or processing of transport streams comprising 3D video content communicated by the 3D-VTU 202. The video processing system 240 may be operable to handle interlaced video fields and/or progressive video frames. In this regard, the video processing system 240 may be operable to decompress and/or up-convert interlaced video and/or progressive video. The video fields, for example, interlaced fields and/or progressive video frames may be referred to as fields, video fields, frames or video frames. In an exemplary aspect of the invention, the video processing system 240 may be operable to generate local graphics and/or to incorporate them, as 3D video data, into received 3D video streams.

The host processor 242 may comprise suitable logic, circuitry, interfaces and/or code that may be operable to process data and/or control operations of the video processing system 240. In this regard, the host processor 242 may be operable configure and/or controlling operations of various other components and/or subsystems of the video processing system 240, by providing, for example, control signals to various other components and/or subsystems of the video processing system 240. The host processor 242 may also control data transfers within the video processing system 240, during video processing operations for example. The host processor 242 may enable execution of applications, programs and/or code, which may be stored in the system memory 244, to enable, for example, performing various video processing operations such as decompression, motion compensation operations, interpolation or otherwise processing 3D video data. The system memory 244 may comprise suitable logic, circuitry, interfaces and/or code that may operable to store information comprising parameters and/or code that may effectuate the operation of the video processing system 240. The parameters may comprise configuration data and the code may comprise operational code such as software and/or firmware, but the information need not be limited in this regard. Additionally, the system memory 244 may be operable to store 3D video data, for example, data that may comprise left and right views of stereoscopic image data.

The video decoder 246 may comprise suitable logic, circuitry, interfaces and/or code that may be operable to process encoded video data. In this regard, the video decoder 246 may be operable to demultiplex and/or parse received transport streams to extract streams and/or sequences within them, and/or to decompress video data that may be carried via the received transport streams, and/or may perform additional security operations such as digital rights management. The compressed video data in the received transport stream may comprise 3D video data corresponding to a plurality of stereoscopic video based view sequences of frames or fields, such as left and right views. The received video data may be compressed and/or encoded via MPEG-2 transport stream (TS) protocol or MPEG-2 program stream (PS) container formats, for example. In various embodiments of the invention, the left view data and the right view data may be received in separate streams or separate files. In this instance, the video decoder 246 may decompress the received separate left and right view video data based on, for example, MPEG-2 MVP, H.264 and/or MPEG-4 advanced video coding (AVC) or MPEG-4 multi-view video coding (MVC). In other embodiments of the invention, the stereoscopic left and right views may be combined into a single sequence of frames. For example, side-by-side, top-bottom and/or checkerboard lattice based 3D encoders may convert frames from a 3D stream comprising left view data and right view data into a single-compressed frame and may use MPEG-2, H.264, AVC and/or other encoding techniques. In this instance, the video data may be decompressed by the video decoder 246 based on MPEG-4 AVC and/or MPEG-2 main profile (MP), for example.

The memory and playback module 248 may comprise suitable logic, circuitry interfaces and/or code that may be operable to buffer video data, which may comprise, for example, stereoscopic 3D video based left and/or right views, while it is being transferred from one process and/or component to another. In this regard, the memory and playback module 248 may receive data from the video decoder 246 and may transfer data to the video processor 250, the video blender 254, and/or the display transform module 256. In addition, the memory and playback module 248 may buffer decompressed reference frames and/or fields, for example, during frame interpolation and/or contrast enhancement processing operations. The memory and playback module 248 may exchange control signals with the host processor 242 for example and/or may write data to the system memory 244 for longer term storage.

The video processor 250 may comprise suitable logic, circuitry, interfaces and/or code that may be operable to perform video processing operations on received video data to facilitate generating corresponding output video streams, which may be played, for example, via the display 260. The video processor 250 may be operable, for example, to generate video frames and/or fields that may provide 3D video playback via the display 260 based on a plurality of view sequences extracted from the received streams. In this regard, the video processor 250 may utilize the video data, such as luma and/or chroma data, in the received view sequences of frames and/or fields.

The graphics processor 254 may comprise suitable logic, circuitry, interfaces and/or code that may be operable to perform graphic processing locally within the video processing system 240. The graphics processor 254 may be operable to generate graphic objects that may be composited and/or incorporated into the output video stream. In this regard, the local graphics may comprise on-screen display (OSD) graphics, which may provide a user interface that enable video playback, control and/or setup.

In accordance with an embodiment of the invention, the graphic objects may be generated based on the focal point of view. In this regard, the graphic objects may be generated and/or processed such that corresponding graphics displayed on screen may correlate to and/or be superimposed on, for example, areas deemed to be the point of focus (e.g. foreground) of the displayed video images. The generated graphic objects may comprise 2D graphic objects. In an exemplary aspect of the invention, in instances where the received video input stream comprises 3D video content, the graphics processor 254 may covert the 2D graphics objects to 3D video data such that the 3D graphics data may be blended into the received 3D video content. Alternatively the graphics processor 254 may generate the local graphics as 3D video. In some embodiments of the invention the graphics processor 254 may share, during graphics processing, functionality utilized to facilitate video processing of received input video stream. In this regard, some of the processing performed to generate the 2D graphics content and/or the conversion to 3D graphics data may be performed, for example, via the video processor 250 where the video processor 250 may be utilized to performed similar operation on received 3D input video.

The video blender 254 may comprise suitable logic, circuitry, interfaces and/or code that may be operable to blend locally generated graphics with received input video data. The video blender 254 may blend the local graphics with the received input video data on per-view basis. In this regard, in instances where the input video stream may comprise stereoscopic 3D video based left and right view sequences, the video blender 254 may be operable, for example, to blend left graphics sequence, generated via the graphics processor 252, with corresponding stereoscopic left view video sequence, and/or to blend right graphics sequence, generated via the graphics processor 252, with corresponding stereoscopic right view video sequence. The video blender 254 may also be operable to combine the resulting blended sequence to generate a combined 3D output stream that may be forwarded to the display transform module 256 for playback via the display 260.

The display transform module 256 may comprise suitable logic, circuitry, interfaces and/or code that may be operable to process video data generated and/or processed via the video processing system 240 to generate an output video stream that is suitable for playback via the display 260. In this regard, the display transform module 256 may perform, for example, frame upconversion based on motion estimation and/or motion compensation to increase the number of frames where the display 260 has higher frame rate than the input video streams. In an exemplary aspect of the invention, instances where the display 260 is not 3D capable, the display transform module 256 may be operable, to convert 3D video data generated and/or processed via the video processing system 240 to 2D output video. In this regard, the 3D video converted to 2D output stream may comprise blended 3D input video and 3D graphics.

The display 260 may comprise suitable logic, circuitry, interfaces and/or code that may be operable to receive reconstructed fields and/or frames of video data after processing in the display transform module 256 and may display corresponding images. The display 260 may be a separate device, or the display 260 and the video processing system 240 may implemented as single unitary device. The display 260 may be operable to perform 2D and/or 3D video display. In this regard, a 2D display may be operable to display video that was generated and/or processed utilizing 3D techniques.

In operation, the video processing system 240 may be utilized to facilitate reception and processing of transport stream comprising video data, and to generate and process output video streams that are playable via a local display device, such as the display 260. Processing the received transport stream may comprise demultiplexing the transport stream to extract plurality of compressed video, which may correspond to, for example, view sequences and/or additional information. Demultiplexing the transport stream may be performed within the video decoder 246, or via a separate component (not shown). The video decoder 246 may be operable to receive the transport streams comprising compressed stereoscopic video data, in multi-view compression format for example, and to decode and/or decompress that video data. For example, the received transport streams may comprise left and right stereoscopic views. The video decoder 246 may be operable to decompress the received stereoscopic video data and may buffer the decompressed data via the memory and playback module 248. The decompressed video data may then be processed to enable playback via the display 260. The video processor 250 may be operable to generate output video streams, which 3D and/or 2D, based on decompressed video data. In this regard, where stereoscopic 3D video is utilized, the video processor 250 may process decompressed reference frames and/or fields, corresponding to plurality of view sequences, which may be retrieved via the memory and playback module 248, to enable generation of corresponding 3D video steam that may be further processed via the display transform module 256 and/or the graphics processor 252 prior to playback via the display 260. For example, where necessary the display transform module 256 may perform motion compensation and/or may interpolate pixel data in one or more frames between the received frames in order to enable the frame rate up-conversion. The graphics processor 252 may be utilized to provide local graphics processing, to enable splicing, for example, graphics into the generated and enhanced video output stream, and the final video output stream may then be played via the display 260.

In various embodiments of the invention, the video processing system 240 may be operable to generate and/or incorporate local graphics into received 3D video streams. In this regard, the local graphics may comprise on-screen display (OSD) graphics, substantially as described with regard to, for example, FIG. 1. The local graphics may comprise, for example, images superimposed on a screen during playback of received video streams to show increase/decrease in the volume, time, and/or channel info. The local graphics may be generated via the graphics processor 252, and may initially be generated as 2D video content. The local graphics may be then be converted to 3D graphics content, via the graphics processor 252 for example, to facilitating blending the local graphics with the input 3D video content. For example, in instances where the received 3D video content comprises stereoscopic video based view sequences of frames and/or fields, such as left and right view sequences, the local graphics may be converted to 3D graphics that may comprise plurality of sequences, each of which may correspond to a view sequence in the received 3D video stream. The video blender 254 may be operable to blend each of the streams of the locally generated 3D graphics with the corresponding view sequence in the received video stream. For example, the video blender 254 may blend the left graphics stream, with corresponding stereoscopic left view video sequence, and/or to blend the right graphics stream with corresponding stereoscopic right view video sequence.

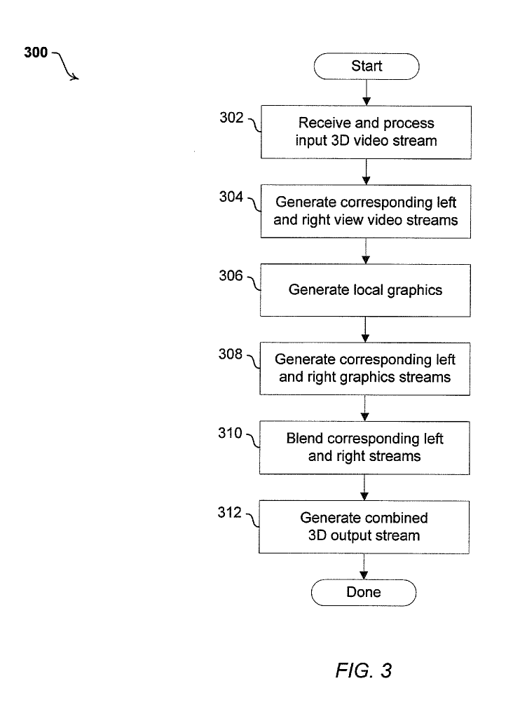

FIG. 3 is a flow chart that illustrates exemplary steps for generating 3D output video with 3D local graphics from 3D input video, in accordance with an embodiment of the invention. Referring to FIG. 3, there is shown a flow chart 300 comprising a plurality of exemplary steps that may be performed to enable generating 3D output video with 3D local graphics from 3D input video.

In step 302, 3D input video stream may be received and processed. For example, the video processing system 240 may be operable to receive and process input video streams comprising uncompressing compressed video data, which may correspond to stereoscopic 3D video. In this regard, the compressed video data may correspond to a plurality of view sequences of video frames or fields, comprising left and right view sequences for example, that may be utilized to render 3D images via a suitable display device, such as the display 260 for example. In step 304, a plurality of view sequences, comprising left and right view video sequences of frames or fields for example, may be generated based on received 3D input streams. The left and right video streams may be utilized to enable generation of a corresponding output video stream, which may be played back via the display 260 for example, after further processing and/or enhancement. In step 306, local graphics, which may be incorporated into the output video stream communicated to the display 260, may be generated. In this regard, the local graphics may comprise on-screen display (OSD) graphics, which may be superimposed on the screen during playback to facilitate, for example, user interfacing, substantially as described with regard to FIG. 1. The local graphics may be generated, for example, via the graphics processor 252, and may initially be generated as 2D video content.

In step 308, the local graphics may be converted to 3D data. For example, the graphics processor 252 may be operable to convert local graphics initially generated as 2D content to 3D graphics comprising a plurality of view sequences. In instances where the input video stream may comprise stereoscopic 3D video with left and right video streams, the 2D local graphics may be converted to 3D graphics comprising left and right graphics streams. In step 310, the local graphics may be blended into the received video stream on per-sequence basis. In this regard, in instances where the received 3D input videos stream comprises stereoscopic left and right view video sequences, for example, the left graphics sequence may blended with the corresponding stereoscopic left view video sequence, and/or the right graphics sequence may be blended with the corresponding stereoscopic right view video sequence. In step 312, a 3D output video stream comprising both received video content and local graphics may be generated. In this regard, the 3D output video stream may be generated based on the plurality of combined sequences that are generated from blending respective view video and graphics sequences.

Various embodiments of the invention may comprise a method and system for generating 3D output video with 3D local graphics from 3D input video. The video processing system 240 may receive input video stream comprising compressed video data corresponding to a plurality of view sequences. The video processing system 240 may then decompress the compressed video data and/or extracting a plurality of view sequences via the video decoder 246 and/or the video processor 250. The video processing system 240 may generate, via the graphics processor 252, a plurality of graphics sequences which may correspond to local graphics content generated in the video processing system 240. The plurality of local graphics may then be blended, via the video blender 254, with the plurality of view sequences by blending each graphics sequence with a corresponding view sequence, to generate a plurality of combined sequences.

The local graphics content may comprise on-screen display (OSD) graphics. The local graphics content may initially be generated, via the graphics processor 252, as 2D graphics. The graphics processor 252 and/or the video processor 250 may be operable to convert the local graphics content into 3D graphics, which correspond to the plurality of graphics sequences. The plurality of graphics sequences may be generated from the local graphics content, based on the input 3D video stream, user input, and/or preconfigured conversion parameters. In this regard, the video processor 252 may be operable to analyze the video data corresponding to the input 3D video stream to generate control information that may be communicated to the graphics processor 252. Alternatively, a dedicated analyzer (not shown) maybe be utilized to analyze the input 3D video stream to generate control signals which may be utilized to control operations of the video processor 250 and/or the graphics processor 252 during generation of plurality of graphics sequences. The extracted plurality of view sequences may comprise, for example, stereoscopic left and right view sequences of frames or fields. Accordingly, when generating the plurality of graphics sequences, left and right graphics sequences, which correspond to the stereoscopic left and right view sequences, may be generated. The right graphics sequence may then be blended, via the video blender 254, with the stereoscopic right view sequence and/or the left graphics sequence may be blended, via the video blender 254, with the stereoscopic left view sequence. After blending the plurality of graphics sequences with the plurality of the view sequences, the video processing system 240 may generate, via the video blender 254 and/or the video processor 250, a three-dimension (3D) output video stream based on the plurality of combined sequences, for playback via the display 260. The generated 3D output video stream may be transformed, via the display transform module 256, to 2D video stream if 3D playback is not available via the display 260.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for generating 3D output video with 3D local graphics from 3D input video.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video processing, the method comprising:
performing by one or more processors and/or circuits in a video processing system:
extracting a plurality of view sequences from a compressed three-dimensional (3D) input video stream;
generating a plurality of graphics sequences that correspond to local graphics content, wherein said plurality of graphics sequences correspond to said extracted plurality of view sequences; and
blending said plurality of graphics sequences with corresponding view sequences from said extracted plurality of view sequences to generate a plurality of combined sequences.

2. The method according to claim 1, wherein said local graphics content comprises on-screen display (OSD) graphics.

3. The method according to claim 1, comprising generating said local graphics content as two-dimensional (2D) video graphics data prior to said generation of said plurality of graphics sequences.

4. The method according to claim 3, comprising converting said 2D video graphics data to said plurality of graphics sequences.

5. The method according to claim 4, comprising converting said 2D video graphics data to said plurality of graphics sequences based on video information for said input 3D video stream, user input, and/or preconfigured conversion parameters.

6. The method according to claim 1, comprising generating a 3D output video stream for display via a display device based on said plurality of combined sequences.

7. The method according to claim 6, comprising transforming said generated 3D output video stream to 2D video stream if said display device is only 2D-capable.

8. The method according to claim 1, wherein said extracted plurality of view sequences comprises stereoscopic left and right view sequences of frames or fields.

9. The method according to claim 8, comprising generating left and right graphics sequences that correspond to said stereoscopic left and right view sequences.

10. The method according to claim 9, comprising blending said right graphics sequence with said stereoscopic right view sequence and/or blending said left graphics sequence with said stereoscopic left view sequence.

11. A system for video processing, the system comprising:
one or more circuits and/or processors that are operable to extract a plurality of view sequences from a compressed three-dimensional (3D) input video stream;
said one or more circuits and/or processors are operable to generate a plurality of graphics sequences that correspond to local graphics content, wherein said plurality of graphics sequences correspond to said extracted plurality of view sequences; and
said one or more circuits and/or processors are operable to blend said plurality of graphics sequences with corresponding view sequences from said extracted plurality of view sequences to generate a plurality of combined sequences.

12. The system according to claim 11, wherein said local graphics content comprises on-screen display (OSD) graphics.

13. The system according to claim 11, wherein said one or more circuits and/or processors are operable to generate said local graphics content as two-dimensional (2D) video graphics data prior to said generation of said plurality of graphics sequences.

14. The system according to claim 13, wherein said one or more circuits and/or processors are operable to convert said 2D video graphics data to said plurality of graphics sequences.

15. The system according to claim 14, wherein said one or more circuits and/or processors are operable to convert said 2D video graphics data to said plurality of graphics sequences based on video information for said input 3D video stream, user input, and/or preconfigured conversion parameters.

16. The system according to claim 11, wherein said one or more circuits and/or processors are operable to generate a 3D output video stream for display via a display device based on said plurality of combined sequences.

17. The system according to claim 16, wherein said one or more circuits and/or processors are operable to transform said generated 3D output video stream to 2D video stream if said display device is only 2D-capable.

18. The system according to claim 11, wherein said extracted plurality of view sequences comprises stereoscopic left and right view sequences of frames or fields.

19. The system according to claim 18, wherein said one or more circuits and/or processors are operable to generate left and right graphics sequences that correspond to said stereoscopic left and right view sequences.

20. The system according to claim 19, wherein said one or more circuits and/or processors are operable to blend said right graphics sequence with said stereoscopic right view sequence and/or to blend said left graphics sequence with said stereoscopic left view sequence.
